(19) United States
(12) Patent Application Publication
(10) Pub. No.: US 2013/0272114 A1
(43) Pub. Date: Oct. 17, 2013

(54) PSEUDO WIRE SWITCHING METHOD AND DEVICE

(71) Applicant: Jinrong Ye, Beijing (CN)

(72) Inventor: Jinrong Ye, Beijing (CN)

(73) Assignee: HANGZHOU H3C TECHNOLOGIES CO., LTD., HANGZHOU (CN)

(21) Appl. No.: 13/992,688

(22) PCT Filed: Dec. 29, 2011
(86) PCT No.: PCT/CN2011/084911

§ 371 Date: Jun. 7, 2013

(30) Foreign Application Priority Data
Jan. 5, 2011 (CN) 201110000953.4

(51) Int. Cl. H04L 12/56

(52) U.S. Cl. CPC H04L 45/28
USPC 370/219

(57) ABSTRACT

A Pseudo Wire (PW) switching method applied to a MPLS L2VPN comprising U-PE devices and N-PE devices includes checking, by an N-PE device, connectivity of a main U-PW and a backup U-PW between the N-PE device and a U-PE device and connectivity of N-PWs between the N-PE device and other N-PE devices. When one of the main U-PW and the backup U-PW is detected to have failed, transmitting, by the N-PE device, a MAC address clear command through an N-PW in a VSI to which the failed U-PW belongs, and clearing, by an N-PE device receiving the MAC address clear command, MAC addresses associated with the N-PW for transmitting the MAC address clear command in the VSI; and when one of the N-PWs is detected to have failed, transmitting a traffic rerouting command through a U-PW in a VSI to which the failed N-PW belongs and performing U-PW switching.

### BACKGROUND

Multi-protocol Label Switching (MPLS) is a technology for transmitting an IP packet via a network by using a label bound in the IP packet. At present, MPLS is widely applied in Virtual Private Networks (VPNs). MPLS VPN adopts a label switching technology, in which one label corresponds to one piece of customer data traffic in order to separate different pieces of customer data traffic. MPLS can optimize the configuration of network resources to a larger degree and can automatically and rapidly eliminate network failures, so as to provide high availability and reliability. MPLS based layer 2 VPN is a network in which a service provider provides services of the second layer for customers, and is called an MPLS L2VPN.

The MPLS L2VPN typically includes Virtual Private Wire Services (VPWS) adopting a point-to-point mode and Virtual Private LAN Services (VPLS) adopting a point-to-multipoint mode. The service provider configures a L2 connection (that is, a Pseudo Wire (PVV)) between two nodes in a specific customer network. A packet from a Customer Edge Router (CE) of a customer node is transmitted transparently to a CE of another node via the PW. The PW is composed of a pair of unidirectional Label Switched Path Virtual Circuits (LSP VCs) that are opposite in direction with respect to each other.

### BRIEF DESCRIPTION OF THE DRAWINGS

FIG. 1 is a schematic diagram illustrating the network structure of a conventional VPWS.

FIG. 2 is a schematic diagram illustrating the network structure of a conventional VPLS.

FIG. 3 is a schematic diagram illustrating the network structure of a conventional H-VPLS.

FIG. 4 is a schematic diagram illustrating the network structure of a conventional PW redundancy H-VPLS.

FIG. 5 is a schematic diagram illustrating the network structure of a conventional H-VPLS composed of a VPWS and a VPLS.

FIG. 6 is a schematic diagram illustrating the network structure of a conventional PW redundancy H-VPLS composed of a VPWS and a VPLS.

FIG. 7 is a schematic diagram illustrating a conventional MAC address reclaiming solution in H-VPLS.

FIG. 8 is a schematic diagram illustrating another conventional MAC address reclaiming solution in H-VPLS.

FIG. 9 is a schematic diagram illustrating the failure of a conventional N-PW in H-VPLS.

FIG. 10 is a schematic diagram illustrating a conventional illegal elimination mode for the failure of an N-PW in H-VPLS.

FIG. 11 is a schematic diagram illustrating a conventional legal elimination mode for the failure of an N-PW in H-VPLS.

FIG. 12 is a schematic diagram illustrating a conventional encapsulation head of a PW Associated Channel (PWACH).

FIG. 13 is a schematic diagram illustrating a conventional Protocol Data Unit (PDU) on a PWACH.

FIG. 14 is a schematic diagram illustrating an encapsulation structure of a PW Fast Reroute (FRR) PDU on a PWACH according to an example of the present disclosure.

FIG. 15 is a schematic diagram illustrating a MPLS L2VPN that operates smoothly according to an example of the present disclosure.

FIG. 16 is a schematic diagram illustrating a protection switching solution when a main U-PW has failed according to an example of the present disclosure.

FIG. 17 is a schematic diagram illustrating a failure wait procedure according to an example of the present disclosure.

FIG. 18 is a schematic diagram illustrating a failure restore procedure according to an example of the present disclosure.

FIG. 19 is a schematic diagram illustrating a procedure of manually switching from a main U-PW to a backup U-PW according to an example of the present disclosure.

FIG. 20 is a schematic diagram illustrating a procedure of manually switching from a backup U-PW to a main U-PW according to an example of the present disclosure.

FIG. 21 a schematic diagram illustrating a reroute procedure when an N-PW has failed according to an example of the present disclosure.

FIG. 22 a schematic diagram illustrating a restore procedure when an N-PE detects that an N-PW has been restored following a failure according to an example of the present disclosure.

FIG. 23 a schematic diagram illustrating the structure of an N-PE device according to an example of the present disclosure.

FIG. 24 a schematic diagram illustrating the structure of a U-PE device according to an example of the present disclosure.

### DETAILED DESCRIPTION

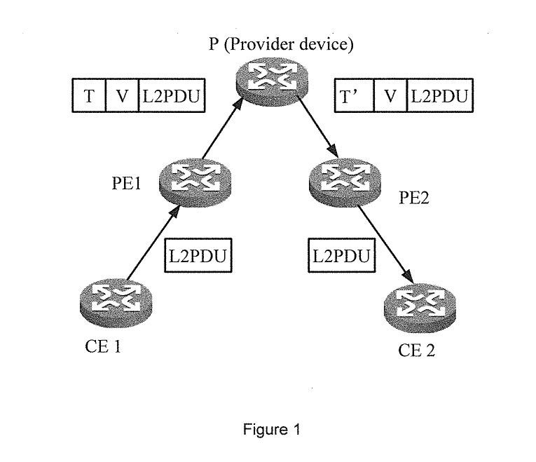

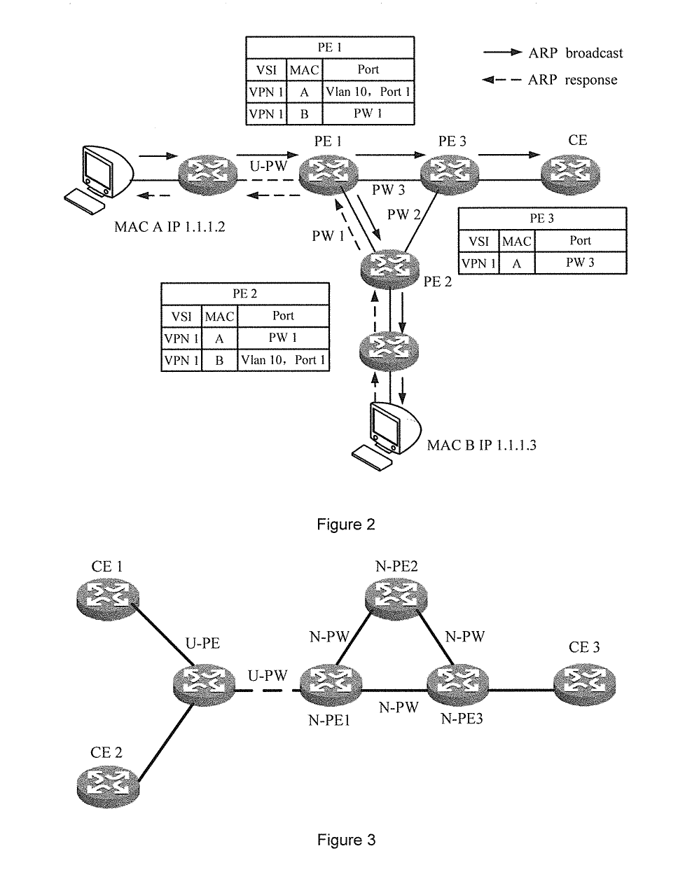

FIG. 1 shows the network structure of a conventional VPWS, and FIG. 2 shows the network structure of a conventional VPLS. A Customer Edge (CE) device is connected with a Service Provider (SP) via an interface. The CE device may be a router, a switch or a host computer. The CE device is unable to perceive a VPN, and does not need to support MPLS. A Provider Edge (PE) device is connected with the CE device, and is responsible for the access of VPN services. The PE device performs the mapping and forwarding of a packet from a private network to a public network tunnel or from a public network tunnel to a private network.

In an Ethernet VPLS environment, the PE device maintains a Virtual Switch Instance (VSI). The VSI is a particular two-layer forwarding list of a VPLS of each customer. The PE device creates a separate VSI according to forwarding information needed for switching Ethernet frames in a specific VPLS VPN. Through the VSI created by the PE device, Media Access Control (MAC) address learning may be implemented.

The VPLS provides accessibility through the MAC address learning. Each PE device maintains one MAC address list. A typical operation of the VPLS is remote MAC address learning.

A PW is composed of a pair of unidirectional LSP VCs that are opposite in direction with respect to each other, and the PW is not up unless the LSP VCs are both up. When a packet is received from an ingress VC LSP, a mapping relation between the source MAC address of the packet and an egress VC LSP is formed. For an Ethernet packet forwarding path indicated by the solid arrows shown in FIG. 2, when PE2 device receives a packet from PW1, the PE2 device adds a MAC forwarding item in which an egress port is the PW1 to a forwarding list.

When the packet is transmitted on a PW, an inner label (that is, a PW label) and an outer tunnel label are added to the packet. The outer tunnel label is used to transmit the packet to an opposite PE device through the label switching of intermediate devices, and the PW label is used by the opposite PE device to find a corresponding VSI after the packet reaches the opposite PE device.

In order to avoid a loop, a two-layer network usually implements a Spanning Tree Protocol (STP). In the VPLS, fully-connected PW and split horizon forwarding are used to avoid the loop. Specifically, PE devices are fully-connected logically (that is, the fully-connected PW), that is, for each VPLS forwarding instance, each PE device creates a PW tree to other PE devices in the VPLS forwarding instance. Each PE device supports the split horizon forwarding to avoid the loop. According to split horizon forwarding, if a packet is received from a PW, the packet is no longer forwarded to other PWs associated with the VSI to which the PW belongs. In other words, any two PE devices communicate with each other through a PW directly connecting the two PE devices, rather than the packet being forwarded through a third PE device.

The PE devices in one specific VPLS are connected by a full mesh. A relationship between the number of PWs and the number of PE devices in one VPLS instance is the number of PWs=the number of PE devices x (the number of PE devices−1)/2. In a large-scale VPLS network, the number of PWs is very large and the overhead of PW signaling is very large, and thus network management and network expansion become complex. In order to simplify network management and improve network expansibility, the network structure of Hierarchical VPLS (H-VPLS) is introduced.

In H-VPLS, the PE device includes a Network facing Provider Edge (N-PE) device and a User facing Provider Edge (U-PE) device. The U-PE device is taken as a Multi-Tenant Unit (MTU) when a customer accesses a VPN, and is used to connect CE devices and a service provider network. The N-PE device is located at the edge of a core domain of the VPLS network and is used to provide transparent transmission services of packets on the core network. Establishment of a full-mesh connection between the U-PE device and all N-PE devices is not required, but a full-mesh connection is to be established between the N-PE devices through PWs. The H-VPLS decreases the number of PWs and the overhead of PW signaling by using a hierarchical technology.

A U-PW (User Facing Pseudo-Wire) is a PW connection between a U-PE device and a N-PE device. A N-PW (Network Pseudo-Wire) is a PW connection between two N-PE devices. In the example, shown in FIG. 3, the U-PE device only establishes one U-PW with one N-PE device (N-PE1), and does not establish PWs with other opposite devices. In order to establish the U-PW, a VSI is created on the N-PE1 device and the U-PE device, a peer is designated, and the PWIDs on the two devices are made to be identical.

In the network structure in FIG. 3, the data traffic forwarding procedure may include the following: the U-PE device transmits a packet reported by a CE device to the N-PE1 device and adds a VC label corresponding to the U-PW to the packet, where the VC label is allocated by the N-PE1 device and is taken as a tag for separating multiplexed multiple PWs. After receiving the packet, the N-PE1 device determines, according to the VC label, a VSI to which the packet belongs, adds a VC label corresponding to an N-PW to the packet according to a destination MAC address of the packet, and forwards the packet. When receiving a packet from an N-PW, the N-PE1 device adds a VC label corresponding to the U-PW and transmits the packet to the U-PE device and the U-PE device forwards the packet to a CE device.

When data switching between the CE1 device and the CE2 device is data switching between local CE devices, if the U-PE device has a bridge function, the U-PE device directly forwards a packet between the CE1 device and the CE2 device, without needing to transmit the packet to the N-PE1 device. But, for the first data packet or broadcast packet whose destination MAC address is unknown, the U-PE device will forward the packet to the N-PE1 device through the U-PW when broadcasting the packet of the CE1 device to the CE2 device, and the N-PE1 device copies the packet and forwards the packet to each opposite CE (for instance, the CE3 device).

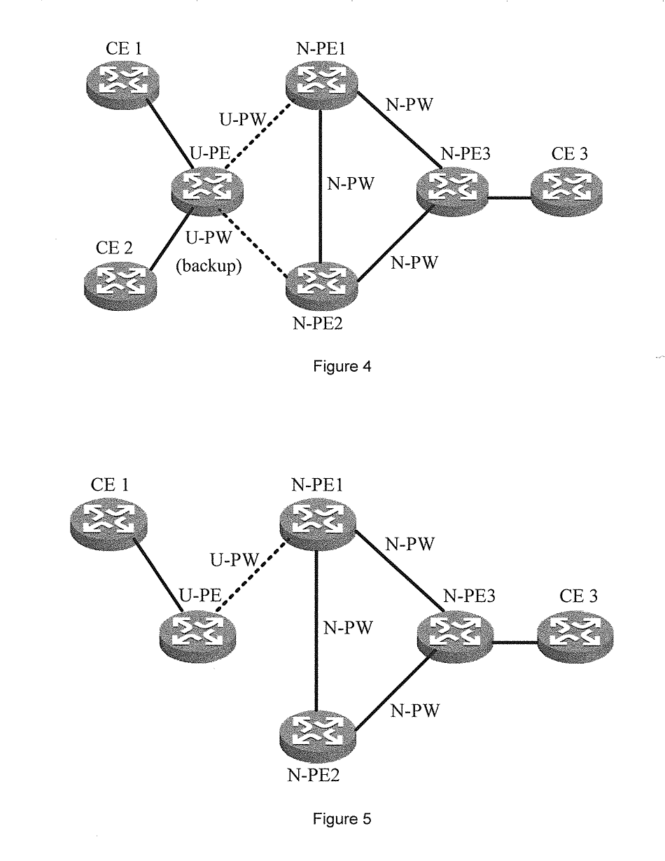

The implementation in which there is only one PW between the U-PE device and the N-PE device (or between the MTU and the PE device) has obvious disadvantages, that is, once the PW has failed, all VPNs connected with the convergence device will lose connectivity. And thus, a backup PW may be configured for the U-PE device in the H-VPLS. That is, the U-PE device is respectively connected with different N-PE devices through a main PW and a backup PW. In a normal case, data traffic is forwarded through the main PW; once the VPLS system detects that the main PW has failed, the backup PW is activated to forward the data traffic. The network structure of this implementation is as shown in FIG. 4.

In the H-VPLS established by interconnecting the VPWS with the VPLS, the U-PE device is directly connected to the N-PE device through the VPWS. The packet is not forwarded according to a MAC address on the U-PE device, but is forwarded according to a point-to-point forwarding mode of the VPWS, that is, is forwarded through a PW that is found according to an ingress interface. Herein, the U-PW is a PW of the VPWS for the U-PE device, instead of a PW of the VPLS. The network structure is as shown in FIG. 5.

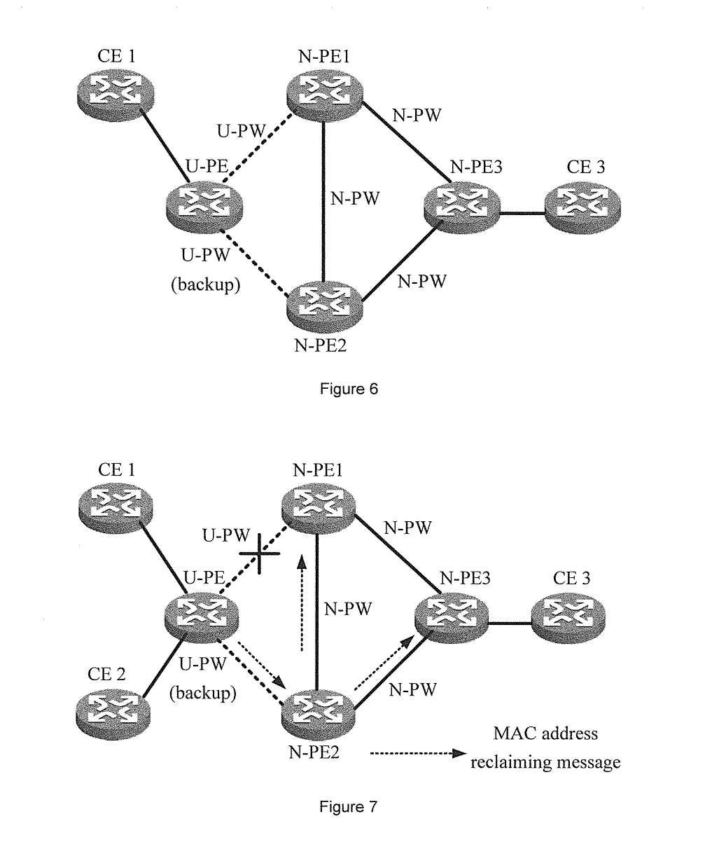

Similarly, in order to improve the reliability of the network, a main PW and a backup PW may be configured for the VPWS of H-VPLS shown in FIG. 5, and the network structure is as shown in FIG. 6.

To sum up, the H-VPLS has two modes, one is two-layer VPLS, that is, the VPLS is configured on both the U-PE device and the N-PE device, which may be called a dual homed U-PE H-VPLS (as shown in FIG. 3 or FIG. 4), and the other one is VPWS+VPLS H-VPLS, that is, the VPWS is configured on the U-PE device, and the VPLS is configured on the N-PE device, which may be called a PW redundancy H-VPLS (as shown in FIG. 5 or FIG. 6).

In the network structure of the dual homed U-PE H-VPLS or the PW redundancy H-VPLS, when the main PW and the backup PW are switched with each other, a MAC address reclaiming processing is to be performed for related N-PE devices, so as to re-learn routing.

As shown in FIG. 7, in the dual homed U-PE H-VPLS, when a PW (for instance, the main PW) between the U-PE device and the N-PE device has failed, the U-PE device activates another PW to perform PW switching. But, in a period of time after the main PW has failed. N-PE devices (for instance, an N-PE3 device shown in FIG. 7) of other nodes still forward the data traffic to the N-PE device (the N-PE1 device shown in FIG. 7) connected with the main PW. When reaching the N-PE device (the N-PE1 device), the data traffic will not continue being forwarded. In order to improve the convergence speed, when the PW switching is performed, other N-PE devices are to be notified as fast as possible to clear a local MAC item in a corresponding VSI, and trigger the re-learning of MAC addresses and reestablishment of a MAC address forwarding path. An address reclaiming message in an LDP protocol (a label distribution protocol) provides the needed mechanism.

The LDP protocol provides two implementations for initiating a MAC address reclaiming message and establishing a message notification path.

In one implementation, the U-PE device initiates a MAC address reclaiming procedure, as shown in FIG. 7. The U-PE device transmits a MAC address reclaiming message to an N-PE device (N-PE2 device) connected with a newly activated PW, and after receiving the MAC address reclaiming message, the N-PE2 device forwards the MAC address reclaiming message to other N-PE devices. The MAC address reclaiming message contains MAC Type, Length, Value (TLV). An N-PE device receiving the MAC address reclaiming message deletes MAC addresses according to parameters in the TLV or re-learns the MAC addresses. When the number of MAC addresses is very large, a null MAC address list may be transmitted to improve the convergence speed. After receiving the MAC address reclaiming message, the N-PE receiving the MAC address reclaiming will delete all MAC addresses in the designated VSI.

The advantages of this implementation include that the U-PE device knows whether a protection mechanism is configured, but the N-PE device does not know whether the protection mechanism is configured; the U-PE device does not need to transmit the MAC address reclaiming message unless the main PW and the backup PW are both configured; otherwise, this implementation may not be used to transmit the MAC address reclaiming message.

The disadvantages of this implementation include that: after receiving the MAC address reclaiming message. N-PE2 device is to transmit the MAC address reclaiming message to other LDP peers that have established an LDP connection; after receiving the MAC address reclaiming message, the LDP peers determine whether the MAC address reclaiming message is transmitted by a PE device at the same layer (there are two layers in the H-VPLS). If yes, the N-PE2 device does not forward the MAC address reclaiming message to other LDP peers; and thus, this implementation is complex; in addition, if the VPWS+VPLS H-VPLS is applied, the U-PE device does not transmit the MAC address reclaiming message, and thus the convergence procedure cannot be accelerated.

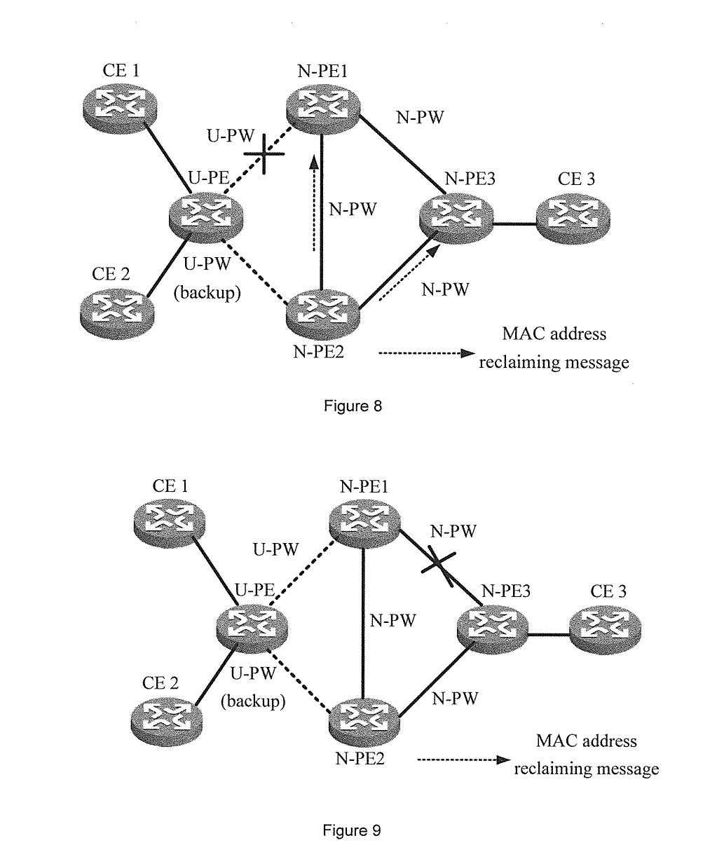

Another implementation is that the newly activated N-PE device (N-PE2 device) initiates a MAC address reclaiming procedure, as shown in FIG. 8.

The disadvantages of this implementation include that: the N-PE device does not know whether both a main PW and a backup PW are configured, and the N-PE device does not need to transmit the MAC address reclaiming message unless the main PW and the backup PW are both configured; otherwise, this implementation may not be used to transmit the MAC address reclaiming message. Thus, the newly activated N-PE device needs an additional mechanism to know whether the MAC address reclaiming message needs to be transmitted.

It can be seen from the above two implementations that, on the one hand, the U-PW switching is implemented at a control plane based on a LDP message of the control plane, and thus the convergence speed is slower than that obtained through direct processing at a data plane. In addition, it is uncertain for the processing of MAC list TLV that the protocol standard adopts which one of the two implementations. On the other hand, when an N-PW has failed, no mechanism is used to accelerate the convergence procedure on the U-PE device.

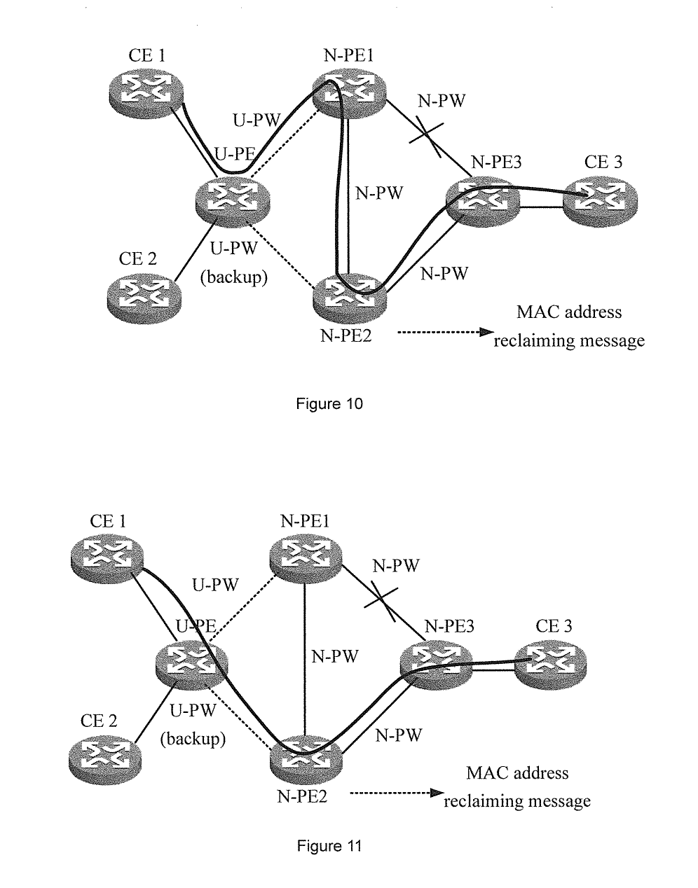

In the above implementations, when an N-PW has failed, as shown in FIG. 9, the U-PE device cannot continue using the main U-PW and must activate the backup U-PW, or else the data traffic will pass through a path as shown in FIG. 10. However, this would cause the device N-PE2 to disobey the principle of split horizon because it receives data traffic from N-PE1 and forwards it to N-PE3, but according to the principle of split horizon a N-PE which receives data traffic from a N-PE should forward the traffic to a U-PE or CPE but should not forward it to another N-PE. Rather, in order to comply with the principle of split horizon, the data traffic after switching should pass through a path as shown in FIG. 11.

In order to solve at least some of the problems discussed above, an example provides a PW switching method applied to a MPLS L2VPN, so as to accelerate the convergence speed of the MPLS L2VPN. In the method, a PWACH (Pseudo Wire Associated Channel) at the data plane is used to implement a relatively complete PW FRR (Pseudo Wire Fast Rerouting) solution. In addition, a protection switching mechanism at the same plane with a checking mechanism is used to avoid the participation of the control plane and improve switching speed. Moreover, the example defines a clear MAC address clear mechanism to solve a restore problem after the N-PW has failed.

Several examples will be illustrated hereinafter in detail with reference to the accompanying drawings.

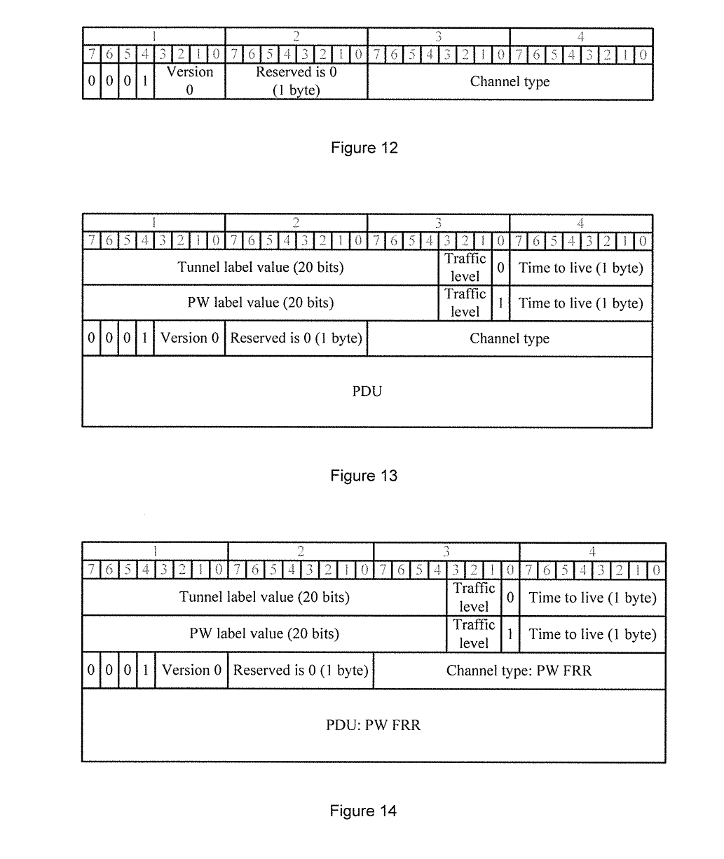

The PWACH (Pseudo-Wire Associated Channel) and the data traffic are multiplexed on a PW, and the PWACH is the same as a forwarding path of the data traffic in a Packet Switch Network (PSN). As shown in FIG. 12, when the PSN adopts MPLS, the PWACH may be identified with an encapsulation head of 4 bytes. Channel type decides the type and format of a packet transmitted on the PWACH. The PWACH is generally used for bearing Operation Administration and Maintenance (OAM) packets, but not used for bearing data traffic. The format of a packet that contains a MPLS tunnel label, a PW label and a PDU (Protocol Data Unit) and is transmitted on the PWACH is shown in FIG. 13.

In an example, a new type of PWACH is defined, which is called a PW FRR (Pseudo Wire Fast Re-Routing). An unused type identification value may be used to identify the type of the PW FRR, for instance, 0x0101. FIG. 14 shows an encapsulation structure of a PW FRR PDU on the PWACH according to an example.

In this example, the states of the main U-PW and the backup U-PW connected with the U-PE include the following types, where the states are defined as the states of the two PWs instead of the state of a single PW.

(1) Normal state: the main PW and the backup PW are both available, and the data traffic is transmitted on the main PW;

(2) Unavailable state: the backup PW is unavailable (because of failure);

(3) Protecting Failure state: the main PW has failed and the data traffic is transmitted on the backup PW;

(4) Protecting Administrative state: a network manager switches the data traffic to the backup PW through a command;

(5) Protecting Redirect state: the main PW and the backup PW are both available, and the data traffic is redirected to the backup PW;

(6) Wait-to-restore state: a state in a restore period controlled by a wait-to-restore timer.

The PW FRR PDU provided by the example may contain any one piece of the above state information. Specifically, fields contained in the PW FRR PDU are shown in Table 1.

TABLE 1
Fields contained in the PW FRR PDU

| Fields | Values | Function descriptions |
|---|---|---|
| Protection switching | | Normal state |
| state or command | | Unavailable state |
| | | Protecting Failure state |
| | | Protecting Administrative state |
| | | Protecting Redirect state |
| | | Wait-to-restore state |
| | | MAC address clear command |
| | | Traffic rerouting command |
| | | Traffic rerouting clear command |
| . . . | . . . | . . . |
| Protection Type (PT) | | No PW protection |
| | | VPWS PW redundancy protection |
| | | Dual homed U-PE VPLS protection |
| | | Reserve |
| PATH | | N-PW |
| | | Main U-PW |
| | | Backup U-PW |
| . . . | . . . | . . . |

When the states of the main U-PW and the backup U-PW change, multiple (for instance, three) PW FRR PDUs (that is, the channel type is the PW FRR PDU, and the following is the same as this) are transmitted continuously and periodically on the backup U-PW, for instance, the period is smaller than or equal to 3.3 ms. In different cases, the values of fields of “protection switching state or command” contained in the PW FRR PDU are different, so that the PE device receiving the PW FRR PDU performs a corresponding operation according the value of the field. The U-PE device usually transmits the PW FRR PDU through the backup U-PW, so as to decrease the interference on the data traffic. In a manual switching procedure, the PW FRR PDU may also be transmitted on the main U-PW.

Processing procedures in various states of the main U-PW and the backup U-PW on the U-PE will be illustrated hereinafter with reference to the accompanying drawings.

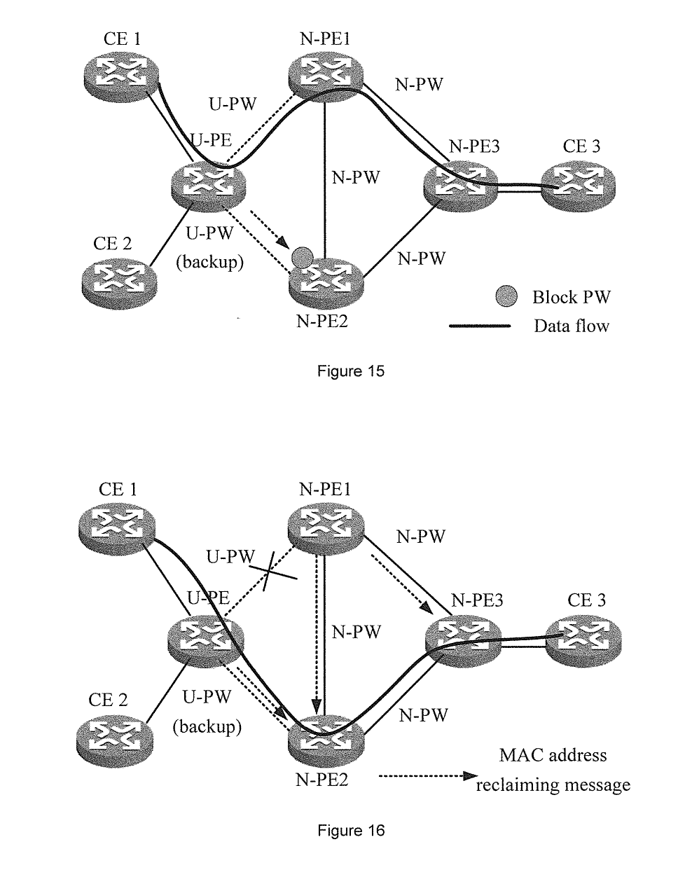

In a normal case, as shown in FIG. 15, the data traffic is transmitted on the main U-PW. After the backup U-PW is available, the U-PE device transmits the PW FRR PDU on the backup U-PW, and the field of “protection switching state or command” contained in the PW FRR PDU is configured as the “Normal state”. An N-PE device (for instance, the N-PE2 device shown in FIG. 15) receiving the PW FRR PDU blocks the backup U-PW. Afterwards, the data traffic is transmitted to the N-PE1 device through the main U-PW, then transmitted to the N-PE3 device through an N-PW, and finally transmitted to an opposite device. The backup U-PW does not receive and transmit data traffic packets, but may receive and transmit OAM packets, which include the PWACH PDU defined by the example.

When the main U-PW has failed and protection switching is needed, as shown in FIG. 16, the procedure includes that: when detecting that the main U-PW has failed, the U-PE device switches uplink data traffic (that is, data traffic from the U-PE device to the N-PE device) to the backup U-PW. Specifically, the U-PE device transmits the PW FRR PDU on the backup U-PW, and the field of “protection switching state or command” contained in the PW FRR PDU is configured as the “Protecting Failure state”. An N-PE device (for instance, the N-PE2 device shown in FIG. 16) receiving the PW FRR PDU activates the backup U-PW, which is in a blocking state. Afterwards, the data traffic and the OAM packets are transmitted to the N-PE2 device through the backup U-PW, then transmitted to the N-PE3 device through an N-PW between the N-PE2 device and the N-PE3 device, and finally transmitted to an opposite device.

The N-PE1 device connected with the main U-PW may detect that the main U-PW has failed. In this case, the protection switching procedure includes that: the N-PE1 device transmits the PW FRR PDU to all N-PWs in a VSI to which the main U-PW belongs, and the field of “protection switching state or command” contained in the PW FRR PDU is configured as the “MAC address clear command”, the N-PE device (for instance the N-PE2 device and the N-PE3 device shown in FIG. 16) receiving the PW FRR PDU clears MAC addresses (that is, the learned MAC address forwarding item through the PW) associated with the N-PW (that is, the N-PW transmitting the PW FRR PDU, and the following is the same as this) receiving the PW FRR PDU in the VSI.

Similarly, the N-PE2 device connected with the backup U-PW may detect that the backup U-PW has failed. In this case, according to the above protection switching procedure, the N-PE2 device transmits the PW FRR PDU to all N-PWs in a VSI to which the backup U-PW belongs, and the field of “protection switching state or command” contained in the PW FRR PDU is configured as the “MAC address clear command”, the N-PE device (for instance the N-PE1 device and the N-PE3 device) receiving the PW FRR PDU clears MAC addresses associated with the N-PW receiving the PW FRR PDU in the VSI.

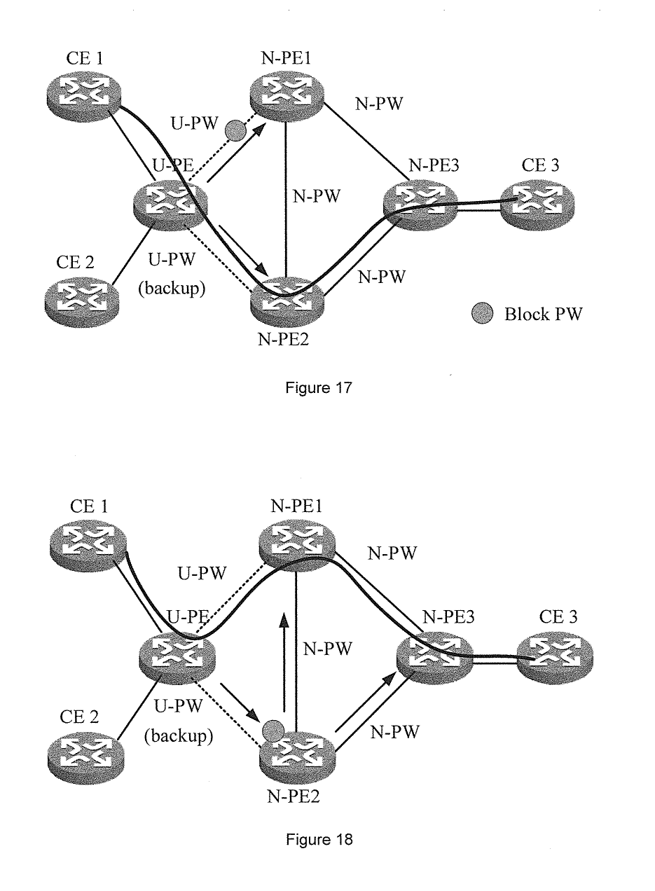

When the MPLS PSN is in a Protecting failure state, if the main U-PW becomes available again and a fall back mode is configured, the MPLS PSN initiates a wait-to-restore procedure, as shown in FIG. 17. The procedure includes that: the U-PE device transmits the PW FRR PDU through the backup U-PW, and the field of “protection switching state or command” contained in the PW FRR PDU is configured as “Wait-to-restore state”; the U-PE device transmits the PW FRR PDU through the main U-PW, and the state of the PW FRR PDU is configured as the “Wait-to-restore state”. After receiving the PW FRR PDU transmitted through the U-PW, if the PW FRR PDU is from the backup U-PW, the N-PE1 device may not process the PW FRR PDU. If the PW FRR PDU is from the main U-PW, the N-PE1 device blocks the main U-PW. In this procedure, because a wait-to-restore timer does not expire, the backup U-PW is still used to transmit the data traffic and the OAM packets.

When the wait-to-restore timer expires, a restore procedure is initiated, that is, a procedure of switching from the backup U-PW to the main U-PW, as shown in FIG. 18. The procedure includes that: if the wait-to-restore timer expires, the MPLS PSN becomes the “Normal state”, the U-PE device transmits the PW FRR PDU through the backup U-PW, and the field of “protection switching state or command” contained in the PW FRR PDU is configured as the “Normal state”. After receiving the PW FRR PDU, the N-PE device (for instance, the N-PE2 device shown in FIG. 18) configures the backup U-PW as a blocking state, and transmits the PW FRR PDU to all N-PWs in the VSI to which the backup U-PW belongs, and the field of “protection switching state or command” contained in the PW FRR PDU is configured as the “MAC address clear”. The N-PE device (for instance, the N-PE1 device and the N-PE3 device shown in FIG. 18) receiving the PW FRR PDU of which the command field is configured as the “MAC address clear” clears the MAC addresses associated with the N-PW receiving the PW FRR PDU in the VSI. Afterwards, the data traffic and the OAM packets are transmitted to the N-PE1 device through the main U-PW, then transmitted to the N-PE3 device through an N-PW between the N-PE1 device and the N-PE3 device, and finally transmitted to an opposite device.

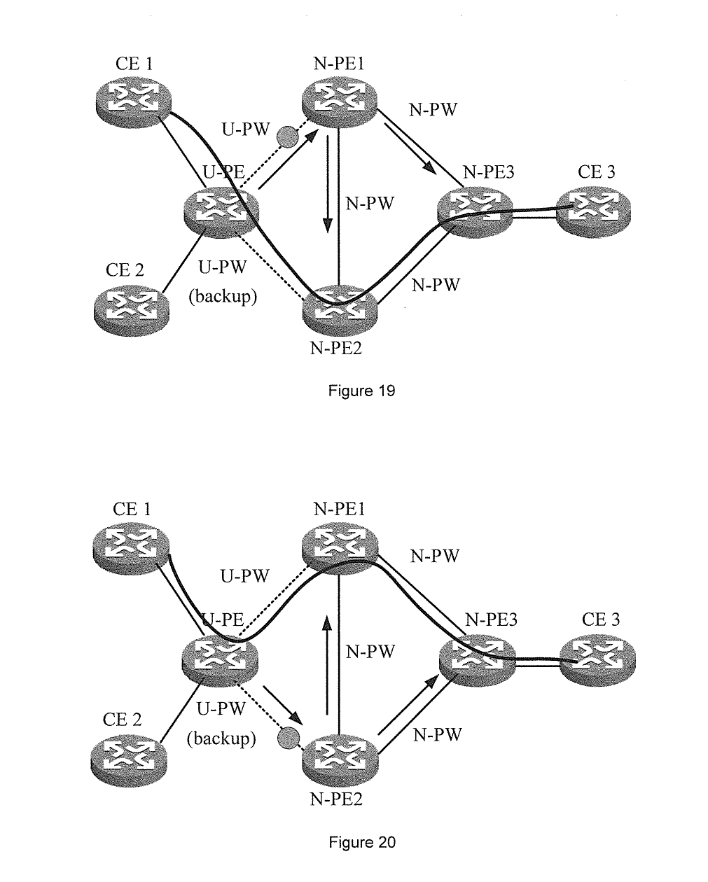

For the manual switching, as shown in FIG. 19, a procedure of switching from the main U-PW to the backup U-PW includes that: the PW FRR PDU is transmitted through the main U-PW (generally, the system manager transmits the PW FRR PDU through the U-PE device, that is, a switching command), and the field of “protection switching state or command” contained in the PW FRR PDU is configured as the “Protecting Administrative state”; after receiving the PW FRR PDU from the main U-PW, the N-PE device (for instance, the N-PE1 device shown in FIG. 19) determines that the N-PE device is to perform the manual switching from the main U-PW to the backup U-PW, further blocks the main U-PW, and transmits the PW FRR PDU on all N-PWs, and the field of “protection switching state or command” contained in the PW FRR PDU is configured as the “MAC address clear”. The N-PE device (for instance, the N-PE2 device and the N-PE3 device shown in FIG. 19) receiving the PW FRR PDU clears the MAC addresses associated with the N-PW receiving the PW FRR PDU in the VSI. Afterwards, the data traffic and the OAM packets are transmitted to the N-PE2 device through the backup U-PW, then transmitted to the N-PE3 device through the N-PW between the N-PE2 device and the N-PE3 device, and finally transmitted to an opposite device.

As shown in FIG. 20, a procedure of manually switching from the main U-PW to the backup U-PW includes that: the PW FRR PDU is transmitted on the backup U-PW, and the field of “protection switching state or command” contained in the PW FRR PDU is configured as “Normal state”; after receiving the PW FRR PDU, the N-PE device (for instance, the N-PE2 device shown in FIG. 20) configures the backup U-PW as a blocking state, and transmits the PW FRR PDU to all N-PWs in the VSI to which the backup U-PW belongs, and the field of “protection switching state or command” contained in the PW FRR PDU is configured as the “MAC address clear”. The N-PE device (for instance, the N-PE1 device and the N-PE3 device shown in FIG. 20) receiving the PW FRR PDU in which the field of “protection switching state or command” is configured as the “MAC address clear” clears the MAC addresses associated with the N-PW receiving the PW FRR PDU in the VSI. Afterwards, the data traffic and the OAM packets are transmitted to the N-PE1 device through the main U-PW, then transmitted to the N-PE3 device through the N-PW between the N-PE1 device and the N-PE3 device, and finally transmitted to an opposite device.

The above examples describe the switching and restore procedure when the U-PW has failed, and an example also describes a switching and restore procedure when an N-PW has failed.

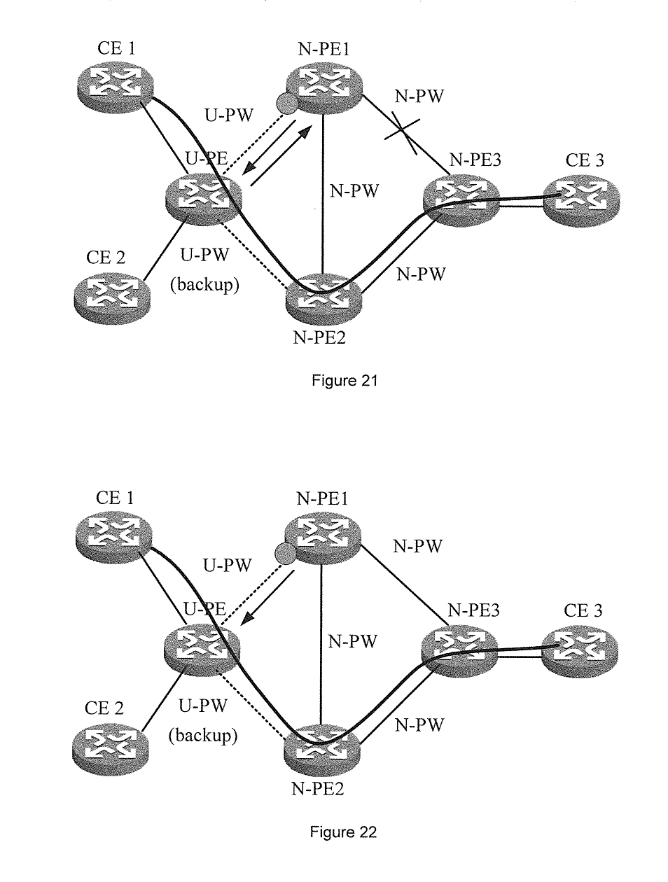

When a certain N-PW has failed, the switching may be implemented through a rerouting procedure. As shown in FIG. 21, when detecting that the N-PW between the N-PE1 device and the N-PE3 device has failed, the N-PE1 device transmits the PW FRR PDU to all U-PWs in the VSI to which the N-PW belongs, and the field of “protection switching state or command” contained in the PW FRR PDU is configured as the “traffic rerouting command”. The U-PE device receiving the PW FRR PDU in which the field of “protection switching state or command” is configured as the “traffic rerouting command” determines whether the main U-PW and the backup U-PW are configured (for instance, makes the determination according to the value of field of “protection type” in the PW FRR PDU). If no, the U-PE device does not process the PW FRR PDU. If yes, the U-PE device switches the data traffic to another available U-PW. The available U-PW may be the main U-PW or the backup U-PW. FIG. 21 shows a procedure of switching from the main U-PW to the backup U-PW. After switching, if the N-PW between the N-PE1 device and the N-PE3 device is restored, but the N-PW between the N-PE2 device and the N-PE3 device has failed, a procedure of switching from the backup U-PW to the main U-PW is initiated, which is similar to the procedure of switching from the main U-PW to the backup U-PW. The U-PE device receiving the PW FRR PUD in which the field of “protection switching state or command” is configured as the “traffic rerouting command” transmits the PW FRR PDU on the PW receiving the PW FRR PDU, and the field of “protection switching state or command” contained in the PW FRR PDU is configured as the “Protecting Redirect”. The device receiving the PW FRR PDU blocks the N-PW receiving the PW FRR PDU, that is, does not receive and transmit the data traffic, but receives and transmits the {]AM packets.

When detecting that a certain N-PW has been restored following a failure, as shown in FIG. 22, the N-PE device transmits the PW FRR PDU to all U-PWs in the VSI to which the N-PW belongs, and the field of “protection switching state or command” contained in the PW FRR PDU is configured as the “traffic rerouting clear command”. The U-PE device receiving the PW FRR PDU determines whether the PW FRR PDU is received from the main U-PW. If no, the U-PE device does not process the PW FRR PDU. If yes, the U-PE device determines, according to the configuration about determining whether to switch from the backup U-PW to the main U-PW, whether to initiate a failure restore procedure of the main U-PW, that is, determines whether the data traffic is to be switched to a forwarding path in the normal state. Specifically, the failure restore procedure of the main U-PW is the same as that described in the foregoing, and will not be described in detail.

It should be noted that, in practical applications, various processing modes provided by the above examples may be used in combination according to different cases, that is, different processing procedures may be used in different cases respectively.

Based on the same technical idea, an example also provides a PE device that can be applied to the above procedures.

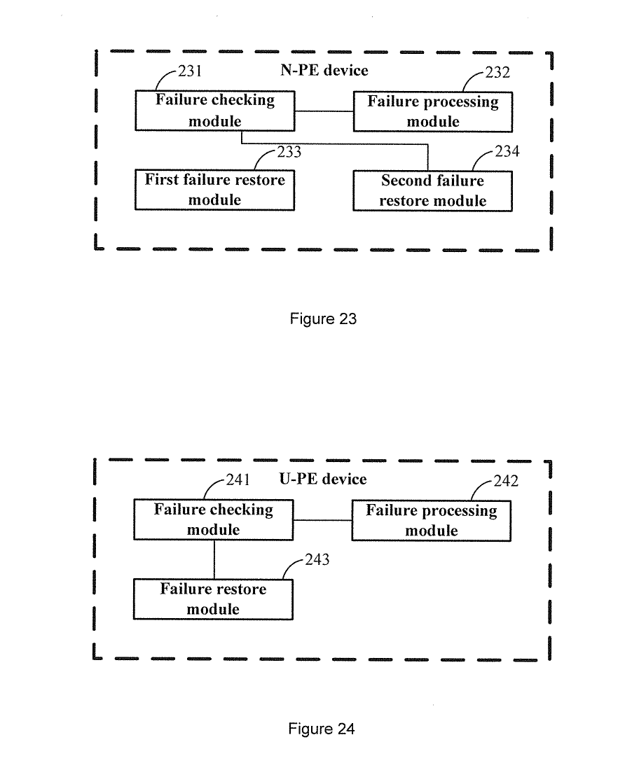

Referring to FIG. 23, an example provides an N-PE device, which may be applied to any one of the procedures shown in FIGS. 16-20. As shown in FIG. 23, the N-PE device includes: a failure checking module 231 and a failure processing module 232, and further includes a first failure restore module 233 and a second failure restore module 234.

The failure checking module 231 is to check connectivity of a main U-PW and a backup U-PW and connectivity of N-PWs.

The failure processing module 232 is to, when the failure checking module 231 detects that one of the main U-PW and the backup U-PW has failed, transmit a MAC address clear command through an N-PW in a VSI to which the failed U-PW belongs, so that an N-PE device receiving the MAC address clear command clears MAC addresses associated with the N-PW for transmitting the MAC address clear command in the VSI. When the failure checking module 231 detects that one of the N-PWs has failed, the failure processing module 232 is to transmit a traffic rerouting command through a U-PW in a VSI to which the failed N-PW belongs, so that a U-PE device receiving the traffic rerouting command performs U-PW switching.

The first failure restore module 233 is to, when receiving normal state indication information transmitted by the U-PE device, transmit the MAC address clear command through the N-PW in the VSI to which the U-PW belongs, so that the N-PE device receiving the MAC address clear command clears the MAC addresses associated with the N-PW for transmitting the MAC address clear command in the VSI, wherein the normal state indication information is transmitted when the U-PE device detects that the failed U-PW returns to normal.

The first failure restore module 233 is further to, before the N-PE device receives the normal state indication information transmitted by the U-PE device and a wait-to-restore timer does not expire, receive wait-to-restore state indication information transmitted by the U-PE device, and block the main U-PW when determining that the wait-to-restore state indication information is from the main U-PW.

In the above N-PE device, the failure processing module 232 is further to, when receiving a command of switching from the main U-PW to the backup U-PW, block the main U-PW according to protecting administrative state indication information contained in the command, and transmit the MAC address clear command through the N-PW in the VSI to which the main U-PW belongs, so that the N-PE device receiving the MAC address clear command clears the MAC addresses associated with the N-PW for transmitting the MAC address clear command in the VSI. When receiving a command of switching from the backup U-PW to the main U-PW, the failure processing module 232 is to block the backup U-PW according to normal state indication information contained in the command and transmit the MAC address clear command to all N-PWs in the VSI to which the U-PW belongs, so that the N-PE device receiving the MAC address clear command clears the MAC addresses associated with the N-PW for transmitting the MAC address clear command in the VSI.

The second failure restore module 234 is to, when the failure checking module detects that the failed N-PW returns to normal, transmit a traffic rerouting clear command to all U-PWs in the VSI to which the N-PW belongs, so that the U-PE device receiving the traffic rerouting clear command switches from the backup U-PW to the main U-PW.

In the above N-PE device, the failure processing module 232 is to transmit a PWACH PDU through the N-PW in the VSI to which the U-PW belongs, where the PWACH PDU contains the MAC address clear command.

In the above N-PE device, the failure processing module 232 is to transmit a PWACH PDU through the U-PW in the VSI to which the N-PW belongs, where the PWACH PDU contains the traffic rerouting command.

Referring to FIG. 24, there is shown an example of a U-PE device, which may be applied to any one of the procedures shown in FIGS. 16-20. The U-PE device includes: a failure checking module 241 and a failure processing module 242, and further includes a failure restore module 243.

The failure checking module 241 is to check connectivity of a main U-PW and a backup U-PW.

The failure processing module 242 is to, when the failure checking module 241 detects that the main U-PW has failed, transmit protecting state indication information through the backup U-PW, so that an N-PE device receiving the protecting state indication information switches data traffic to the backup U-PW.

The failure restore module 243 is to, when the failure checking module 241 detects that the failed main U-PW returns to normal, transmit normal state indication information through the backup U-PW, so that an N-PE device receiving the normal state indication information blocks the backup U-PW, and transmits a MAC address clear command through an N-PW in a VSI to which the backup U-PW belongs.

In the above U-PE device, the failure restore module 243 is further to, before the U-PE device transmits the normal state indication information through the backup U-PW and a wait-to-restore timer does not expire, transmit wait-to-restore state indication information through the main U-PW and the backup U-PW respectively, so that an N-PE receiving the wait-to-restore state indication information through the main U-PW blocks the main U-PW.

In the above U-PE device, the failure processing module 242 is further to, when receiving a command of switching from the main U-PW to the backup U-PW, transmit protecting administrative state indication information through the main U-PW, so that an N-PE device receiving the protecting administrative state indication information through the main U-PW blocks the main U-PW, and transmits the MAC address clear command through the N-PW in the VSI to which the main U-PW belongs. When receiving a command of switching from the backup U-PW to the main U-PW, the failure processing module 242 is to transmit normal state indication information through the backup U-PW, so that an N-PE device receiving the normal state indication information through the backup U-PW blocks the backup U-PW, and transmits the MAC address clear command through the N-PW in the VSI to which the backup U-PW belongs.

In the above U-PE device, the failure processing module 242 is further to, when receiving a traffic rerouting command transmitted by the N-PE device, switch the data traffic to another available U-PW. Correspondingly, the failure restore module 243 is further to, when receiving a traffic rerouting clear command transmitted by the N-PE device, switch the data traffic to the U-PW returning to normal.

It should be noted that, the functions of the modules in the N-PE device provided by the examples above may be implemented through one N-PE device, and the functions of the modules in the U-PE device provided by the examples may be implemented through one U-PE device.

Those skilled in the art can understand that the modules in the devices provided by the examples above may be configured in the devices according to the description in the examples, and may also be configured in one or more devices different from those of the examples after being modified. The various modules in the above examples may be integrated into one module, and may also be separated into multiple sub-modules.

The methods and modules disclosed herein may be realized by software accompanied by general hardware platforms, or by hardware. For instance the methods and modules may be implemented by logic circuitry such as one or more ASICs or integrated circuits or as machine readable instructions stored in a memory and executable by a processor. According to an example, the methods disclosed herein may be in the form of a software product, and the computer software product may be stored in a computer readable storage medium and includes machine-readable instructions to make a computer device (such as a handset, a personal computer, a server or a network device such as a switch or router) perform the methods disclosed herein.

It should be noted that those skilled in the art may make improvements and modifications to the methods and devices disclosed herein within the principles of those methods and devices, and the improvements and modifications are to be covered in the protection scope defined herein.

What is claimed is:

1. A Pseudo Wire (PW) switching method, applied to a Multi-protocol Label Switching based layer 2 Virtual Private Network (MPLS L2VPN) comprising User-facing Provider Edge (U-PE) devices and Network Provider Edge (N-PE) devices, said method comprising:
checking, by an N-PE device, connectivity of a main U-PW and a backup U-PW between the N-PE device and a U-PE device and connectivity of N-PWs between the N-PE device and other N-PE devices;
when one of the main U-PW and the backup U-PW is detected to have failed, transmitting, by the N-PE device, a Media Access Control (MAC) address clear command through an N-PW in a Virtual Switch Instance (VSI) to which the failed U-PW belongs; and
when one of the N-PWs is detected to have failed, transmitting a traffic rerouting command through a U-PW in a VSI to which the failed N-PW belongs.

2. The method of claim 1, further comprising:
when normal state indication information transmitted by the U-PE device is received, transmitting, by the N-PE device, the MAC address clear command through the N-PW in the VSI to which the U-PW belongs, wherein the normal state indication information is transmitted when the U-PE device detects that the failed U-PW returns to normal; and
before the N-PE device receives the normal state indication information transmitted by the U-PE device and a wait-to-restore timer has not expired, receiving, by the N-PE device, wait-to-restore state indication information transmitted by the U-PE device; and
blocking the main U-PW when a determination is made that the wait-to-restore state indication information is from the main U-PW.

3. The method of claim 1, further comprising:
when a command of switching from the main U-PW to the backup U-PW is received, blocking, by the N-PE device, the main U-PW according to protecting administrative state indication information contained in the command, and transmitting the MAC address clear command through the N-PW in the VSI to which the main U-PW belongs; and
when a command of switching from the backup U-PW to the main U-PW is received, blocking, by the N-PE device, the backup U-PW according to normal state indication information contained in the command, and transmitting the MAC address clear command to all N-PWs in the VSI to which the backup U-PW belongs.

4. The method of claim 1, further comprising:
when the failed N-PW is detected to have returned to normal, transmitting, by the N-PE device, a traffic rerouting clear command to all U-PWs in the VSI to which the N-PW belongs, and switching, by the U-PE device receiving the traffic rerouting clear command, from the backup U-PW to the main U-PW.

5. The method of claim 1, wherein the step of transmitting the MAC address clear command through the N-PW in the VSI to which the U-PW belongs comprises:
transmitting, by the N-PE device, a PWACH PDU (PW Associated Channel Protocol Data Unit) through the N-PW in the VSI to which the U-PW belongs, wherein the PWACH PDU contains the MAC address clear command; and
the step of transmitting the traffic rerouting command through the U-PW in the VSI to which the N-PW belongs comprises:
transmitting, by the N-PE device, a PWACH PDU through the U-PW in the VSI to which the N-PW belongs, wherein the PWACH PDU contains the traffic rerouting command.

6. A Network Provider Edge (N-PE) device, applied to a Multi-protocol Label Switching based layer 2 Virtual Private Network (MPLS L2VPN) comprising User-facing Provider Edge (U-PE) devices and N-PE devices, said N-PE device comprising:
a failure checking module to check connectivity of a main U-PW and a backup U-PW and connectivity of N-PWs; and
a failure processing module to, when the failure checking module detects that one of the main U-PW and the backup U-PW has failed, transmit a Media Access Control (MAC) address clear command through an N-PW in a Virtual Switch Instance (VSI) to which the failed U-PW belongs, so that an N-PE device receiving the MAC address clear command clears MAC addresses associated with the N-PW for transmitting the MAC address clear command in the VSI, and to, when the failure checking module detects that one of the N-PWs has failed, transmit a traffic rerouting command through a U-PW in a VSI to which the failed N-PW belongs, so that a U-PE device receiving the traffic rerouting command performs U-PW switching.

7. The N-PE device of claim 6, further comprising:
a first failure restore module to, when a normal state indication information transmitted by the U-PE device is received, transmit the MAC address clear command through the N-PW in the VSI to which the U-PW belongs, so that the N-PE device receiving the MAC address clear command clears the MAC addresses associated with the N-PW for transmitting the MAC address clear command in the VSI, wherein the normal state indication information is transmitted when the U-PE device detects that the failed U-PW returns to normal; and
further to, before the N-PE device receives the normal state indication information transmitted by the U-PE device and a wait-to-restore timer has not expired, receive wait-to-restore state indication information transmitted by the U-PE device, and block the main U-PW when a determination is made that the wait-to-restore state indication information is from the main U-PW.

8. The N-PE device of claim 6, wherein the failure processing module is further to, when a command of switching from the main U-PW to the backup U-PW is received, block the main U-PW according to protecting administrative state indication information contained in the command, and transmit the MAC address clear command through the N-PW in the VSI to which the main U-PW belongs, so that the N-PE device receiving the MAC address clear command clears the MAC addresses associated with the N-PW for transmitting the MAC address clear command in the VSI;
when a command of switching from the backup U-PW to the main U-PW is received, block the backup U-PW according to normal state indication information contained in the command, and transmit the MAC address clear command to all N-PWs in the VSI to which the U-PW belongs, so that the N-PE device receiving the MAC address clear command clears the MAC addresses associated with the N-PW for transmitting the MAC address clear command in the VSI.

9. The N-PE device of claim 6, further comprising:
a second failure restore module to, when the failure checking module detects that the failed N-PW returns to normal, transmit a traffic rerouting clear command to all U-PWs in the VSI to which the N-PW belongs, so that the U-PE device receiving the traffic rerouting clear command switches from the backup U-PW to the main U-PW.

10. The N-PE device of claim 6, wherein the failure processing module is to transmit a PW Associated Channel (PWACH) PDU through the N-PW in the VSI to which the U-PW belongs, wherein the PWACH PDU contains the MAC address clear command, and to transmit a PWACH PDU through the U-PW in the VSI to which the N-PW belongs, wherein the PWACH PDU contains the traffic rerouting command.

11. A User-facing Provider Edge (U-PE) device, applied to a Multi-protocol Label Switching based layer 2 Virtual Private Network (MPLS L2VPN) comprising User-facing Provider Edge (U-PE) devices and Network Provider Edge (N-PE) devices, comprising:
a failure checking module to check connectivity of a main U-PW and a backup U-PW; and
a failure processing module to, when the failure checking module detects that the main U-PW has failed, transmit protecting state indication information through the backup U-PW, so that an N-PE device receiving the protecting state indication information switches data traffic to the backup U-PW.

12. The U-PE device of claim 11, further comprising:
a failure restore module to, when detecting that the failed main U-PW returns to normal, transmit normal state indication information through the backup U-PW, so that an N-PE device receiving the normal state indication information blocks the backup U-PW, and transmits a Media Access Control (MAC) address clear command through an N-PW in a Virtual Switch Instance (VSI) to which the backup U-PW belongs.

13. The U-PE device of claim 11, wherein the failure restore module is further to, before the U-PE device transmits the normal state indication information through the backup U-PW and a wait-to-restore timer has not expired, transmit wait-to-restore state indication information through the main U-PW and the backup U-PW respectively, so that an N-PE receiving the wait-to-restore state indication information through the main U-PW blocks the main U-PW

14. The U-PE device of claim 11, wherein the failure processing module is further to, when a command of switching from the main U-PW to the backup U-PW is received, transmit protecting administrative state indicate information through the main U-PW, so that an N-PE device receiving the protecting administrative state indicate information through the main U-PW blocks the main U-PW, and transmits the MAC address clear command through the N-PW in the VSI to which the main U-PW belongs; and to, when a command of switching from the backup U-PW to the main U-PW is received, transmit normal state indication information through the backup U-PW, so that an N-PE device receiving the normal state indication information through the backup U-PW blocks the backup U-PW, and transmits the MAC address clear command through the N-PW in the VSI to which the backup U-PW belongs.

15. The U-PE device of claim 12, wherein the failure processing module is further to, when a traffic rerouting command transmitted by the N-PE device is received, switch the data traffic to another available U-PW, and wherein the failure restore module is further to, when a traffic rerouting clear command transmitted by the N-PE device is received, switch the data traffic to a U-PW that has returned to normal.
